(19) United States
(12) Patent Application Publication
(10) Pub. No.: US 2008/0029204 A1
(43) Pub. Date: Feb. 7, 2008

(54) Machine and method for assembling a fabric sweeper

(76) Inventor: Jeremy Knopow, Burlington, WI (US)

Correspondence Address: S.C. JOHNSON & SON, INC., 1525 HOWE STREET, RACINE, WI, 53403-2236, US

(21) Appl. No.: 11/498,904

(22) Filed: Aug. 3, 2006

(51) Int. Cl. B32B 37/00

(52) U.S. Cl. 156/212; 156/308.2; 156/582

(57) ABSTRACT

A method and machine for assembling a fabric sweeper having a fabric piece, such as velour, on a rigid part, such as a roller, is disclosed. Fabric is pre-coated with a heat-activated adhesive and cut into fabric pieces. The adhesive on a fabric piece is heated and placed into contact with the roller. A portion of the fabric piece is rolled over and onto the inside of the roller. The adhesive bonds the fabric piece to the roller creating a fabric covered roller assembly. Once the roller assembly is complete it is joined to a base. The base is then connected to a top handle that includes directions for use.

### CROSS-REFERENCE TO RELATED APPLICATIONS

This application claims a benefit of priority on U.S. patent application Ser. No. 29/239,706, filed Oct. 3, 2005, and U.S. patent application Ser. No. 11/450,315 filed on Jun. 10, 2006 both of which claim priority on U.S. patent application Ser. No. 11/141,099, filed May 31, 2005.

### BACKGROUND OF THE INVENTION

1. Field of the Invention

The present invention relates to a machine for making a device for cleaning fabric; specifically, a machine for joining objects of dissimilar materials and for producing an assembly of fabric and a rigid part. The present invention also relates to a method of producing a fabric sweeper and an assembly of fabric and a rigid part.

2. Discussion of the Related Art

Co-pending U.S. patent application Ser. No. 11/450,315, filed Jun. 10, 2006, incorporated hereinafter by reference, discloses a fabric cleaner with a housing that preferably includes at least one movable fabric cleaning member, i.e., a roller. In one embodiment, a pair of rollers is secured within a recess in the housing such that each roller is engageable with the fabric to be cleaned and with the opposed roller. The rollers can easily pick up dust, dirt and other debris from the fabric surface due to their outer surface formed of a material that readily attracts pet hair, crumbs, dust, lint, allergens and other materials present on the fabric surface. The material is also chosen to be somewhat flexible such that the material, in addition to being cleaned by the material positioned on the opposed roller, can be further cleaned of the dirt, dust and other debris picked up by the material as a result of the contact of the material on roller with the housing.

There exist several challenges in making such a fabric cleaner, however. For example, to produce a roller consisting of a fabric piece bonded to a rigid part, the fabric piece may be glued to the rigid part by hand. However, hand assembly is not an option when the roller needs to be mass-produced or consistently produced within high quality specifications. Hand assembling a fabric piece to a rigid part is not an efficient use of resources. It is too time-consuming and repetitive thereby making it prohibitively expensive to produce manually. Similarly, as the rollers described in the co-pending application are major components of a consumer cleaning product, the finished assembly must meet customer expectations in order to win repeat business.

Therefore, it is critical to have a method of mass-producing the fabric sweepers cheaply, quickly and within quality specifications in order for the consumer cleaning product to succeed in the marketplace. Integral to the method of mass-producing the fabric sweepers is to have a machine that produces the rollers quickly and with quality. Therefore, what is needed is a method and machine that aids in the manufacture of fabric sweepers by applying fabric to an entire outer surface of a roller with the remaining fabric folded over and bonded to the inside of the roller.

### SUMMARY AND OBJECTS OF THE INVENTION

According to a primary aspect of the present invention, a method and machine for producing a roller assembly for a fabric cleaner is provided. The method and machine produces the roller assemblies cheaply and quickly while meeting quality expectations.

One embodiment of the present invention is a method of applying a fabric piece, such as velour, to a rigid part, such as a roller. The process begins by coating the entire back side of a roll of fabric with a heat-activated adhesive. After the adhesive has been applied, the roll of fabric is allowed to cool for at least a few seconds. Then the adhesive-coated fabric roll is cut into adhesive-coated fabric pieces shaped to match the rigid parts, e.g., the roller assemblies that they will be attached to. The subsequent steps for applying the fabric piece are detailed below.

One embodiment of the present invention is a machine used in the method to assemble the fabric piece onto the rigid part. The machine is comprised of numerous components. The machine has a base with mounting posts extending outwardly from the base. A first section, or rigid part holding component, has a piece that holds the rigid part in place, a support plate, and a first set of springs. A second section, or pressing component, has a plate and a second set of springs. A third section, or rollover unit, has a roller connected to the plate of the pressing component, or pressing plate via a third set of springs. A fourth section, or holder or fabric carrier, has a cradle, a ramp and a fourth set of springs. A fifth section, or base component, has a base and mounting rods.

A next step in the method of applying a fabric piece to a rigid part is to place a heat-activated adhesive-coated fabric piece in the fabric carrier. The fabric carrier may have a cradle and fabric springs to support the fabric piece and may be removable from the rest of the components. The fabric carrier may have protrusions, or fabric stops, that help align the fabric pieces with notches in the fabric pieces. The fabric piece can be retained in the fabric carrier by any number of methods including gravity, vacuum, spring retention clips, friction, suction cups, or an adhesive.

Heat is then applied to the fabric piece before coming into contact with the rigid part. Preferably, heat can be applied to the adhesive in one of the following manners: passing the carrier through a conveyor-type heat source, heating the fabric carrier which indirectly heats the adhesive, or heating the rigid part which then heats the adhesive once the rigid part comes into contact with the fabric piece. After heat has been applied, a downward force applied against the pressing component causes the rigid part to press against the adhesive-coated fabric piece. The downward force can be applied manually via a handle or can be applied via an actuator.

Preferably, the rigid part continues to press against the fabric piece, eventually sandwiching it between itself and the cradle until the springs of the holding component are fully compressed. At this point, a small end section of the fabric piece is not sandwiched and instead, extends outwardly from the cradle and rigid part. The downward force continues to be exerted against the pressing component and, at this point, the springs of the pressing component begin to be compressed. This causes the roller of the rollover unit to come into contact with the ramp of the fabric carrier. As the pressing springs continue to compress, the roller continues down the ramp while the springs of the rollover unit begin to bend sideways. The roller exerts equal pressure over the width of the ramp. The roller eventually comes into contact with the section of fabric piece not sandwiched between the cradle and rigid part. Due to the constant pressure exerted by the roller on the ramp, the roller is able to get underneath the fabric piece section and fold it over the edge of the rigid body. The rigid body is hollow and the piece holding the rigid body has a cutout that permits the roller to travel into the inside portion of the rigid body. The force exerted when the spring travels down the ramp, over the edge and into the inside portion of the rigid body pushes the fabric piece section to come into contact and thereby bond via the heat-activated adhesive to the rigid body.

After the roller has traveled to the end of the fabric piece section, pressure is released on the machine the springs decompress returning it to its original position.

Preferably, after the rollers are assembled, the rollers are added to a molded base, which has receiving members for the rollers. The base and the rollers are preferably then heat staked to a top handle portion to create the fabric sweeper.

In one embodiment, the inventive steps include: applying a heat activated adhesive to the fabric, cutting the fabric to size, reactivating the heat activated adhesive, and binding the fabric to a roller of the device.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views. In the drawings:

FIG. 1 is a perspective view of one embodiment of a machine for producing an assembly of dissimilar materials for the present invention;

FIG. 2 is a rear perspective view of the machine of FIG. 1.

FIG. 3 is a perspective view of the machine of FIG. 1 showing a rigid part and a fabric piece to be assembled;

FIG. 4 is a perspective view of the machine of FIG. 1 in a fully compressed state with the rigid part and fabric in contact of each other;

FIG. 5 is a view of the machine of FIG. 1 taken along line 5-5;

FIG. 6 is a view of the machine of FIG. 1 taken along line 5-5 showing a rigid part and a fabric piece to be assembled;

FIG. 7 is a view of the machine of FIG. 1 taken along line 5-5 illustrating the initial contact between the rigid part and fabric piece;

FIG. 8 is a view of the machine of FIG. 1 taken along line 5-5 illustrating the fabric rollover operation of the present invention;

FIG. 9 is a bottom plan view of one embodiment of a fabric cleaner incorporating two roller assemblies;

FIG. 10 is a bottom plan view of the fabric cleaner of FIG. 9 with the two roller assemblies rotated outwards;

FIG. 11 is a perspective view of one embodiment of a roller of the present invention;

FIG. 12 is a partial perspective view of the bottom of one embodiment of a fabric cleaner of the present invention showing a method of mounting the roller assemblies to a base piece;

FIG. 13 is a perspective view of the top of a base piece with mounted roller assemblies

FIG. 14 is a perspective view of one embodiment of a fabric sweeper; and

FIG. 15 is a diagram of various graphics of directions of use of a fabric sweeper of the present invention.

In describing the preferred embodiment of the invention that is illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the word connected or terms similar thereto are often used. They are not limited to direct connection but include connection through other elements where such connection is recognized as being equivalent by those skilled in the art.

### DETAILED DESCRIPTION OF A PREFERRED EMBODIMENT

The present invention and the various features and advantageous details thereof are explained more fully with reference to the non-limiting embodiments described in detail in the following description.

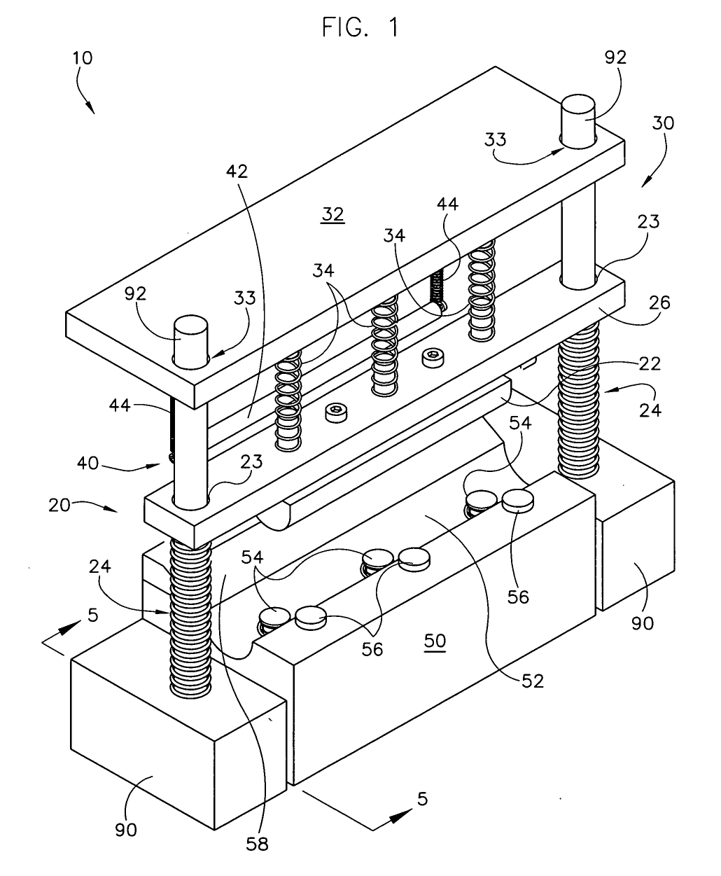

With reference now to the drawing figures in which like reference numerals designate like parts throughout the disclosure, one embodiment of a machine for assembling pieces of a device or fabric sweeper, e.g., a fabric piece and a rigid part, according to the present invention is indicated generally by the reference number 10 in FIG. 1. The preferred device or fabric sweeper is a handheld, self-cleaning device for removing lint, hair and other materials from soft surfaces and containing them. For example, such a device is described in Co-pending U.S. patent application Ser. No. 11/450,315.

The machine 10 preferably includes a first section, e.g., rigid part holding unit 20, a second section, e.g., pressing unit 30, a third section, e.g., rollover unit 40, fourth section, e.g., fabric carrier 50 and a fifth section, e.g., base 90.

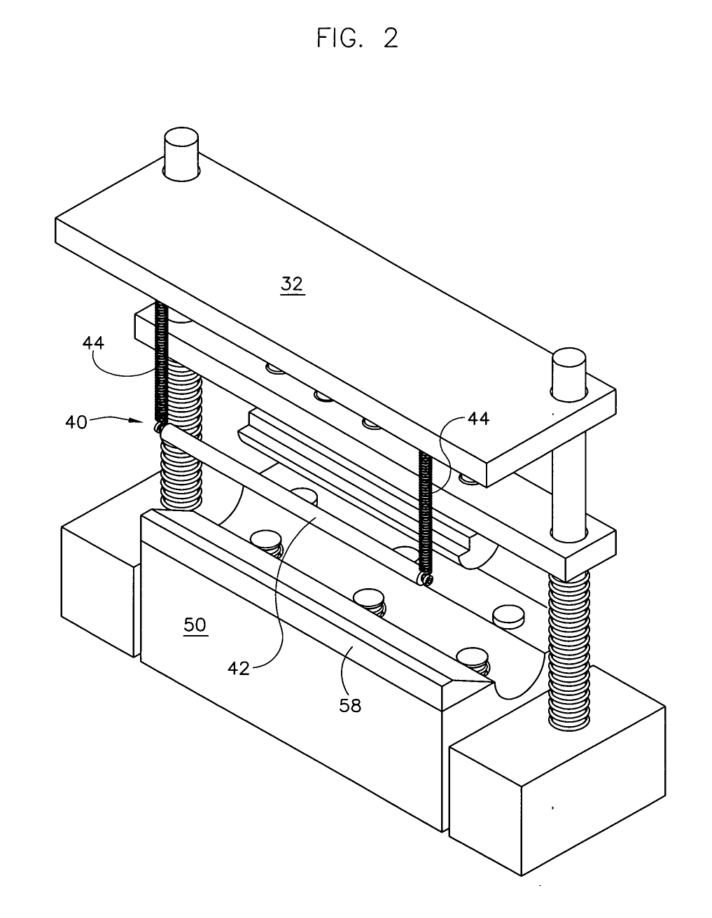

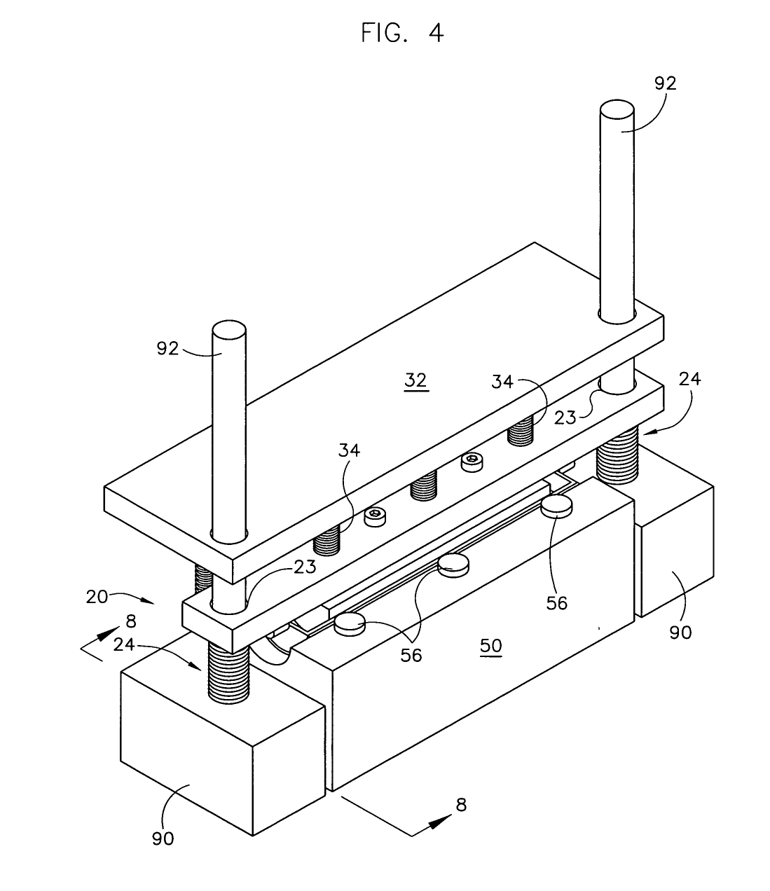

Referring specifically now to one preferred embodiment shown in FIGS. 1-4, the rigid part holding unit 20 is comprised of a rigid part holder 22 connected to a support plate 26. The support plate 26 is attached to support posts 92 via holes 23 and held aloft via holding springs, or biasing members, 24. The pressing unit 30 is comprised of a pressing plate 32 and pressing springs, or biasing members, 34. The pressing plate 32 is attached to the support posts 92 via holes 33 and connected to the support plate 26 via the pressing springs 34. The rollover unit 40 is comprised of rollover springs, or biasing members, 44 and a roller 42 and is connected to one end of the pressing plate 32.

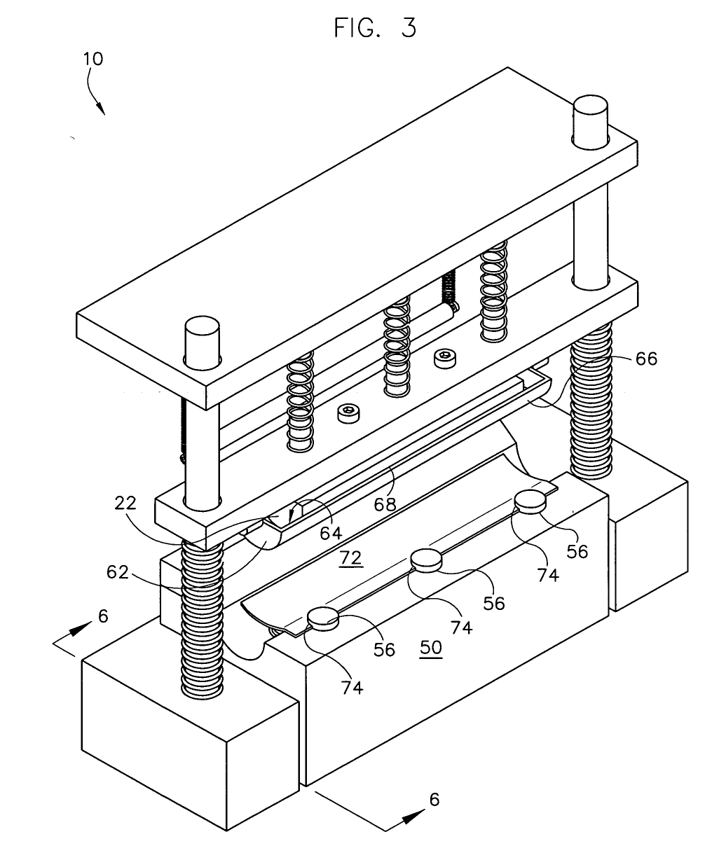

The fabric carrier 50 is comprised of a cradle 52, fabric-supporting springs or biasing members 54, fabric stops 56, and a rollover ramp 58. FIG. 3 shows a fabric piece 72 placed in the cradle 52 of the fabric carrier 50. The fabric piece 72 preferably has scallop cuts, or notches, 74 to help assure proper placement of the fabric piece 72 by aligning with fabric stops 56. The fabric piece 72 slightly compresses and rests on the fabric supporting springs 54. A rigid part 62 is held in place by the rigid part holder 22.

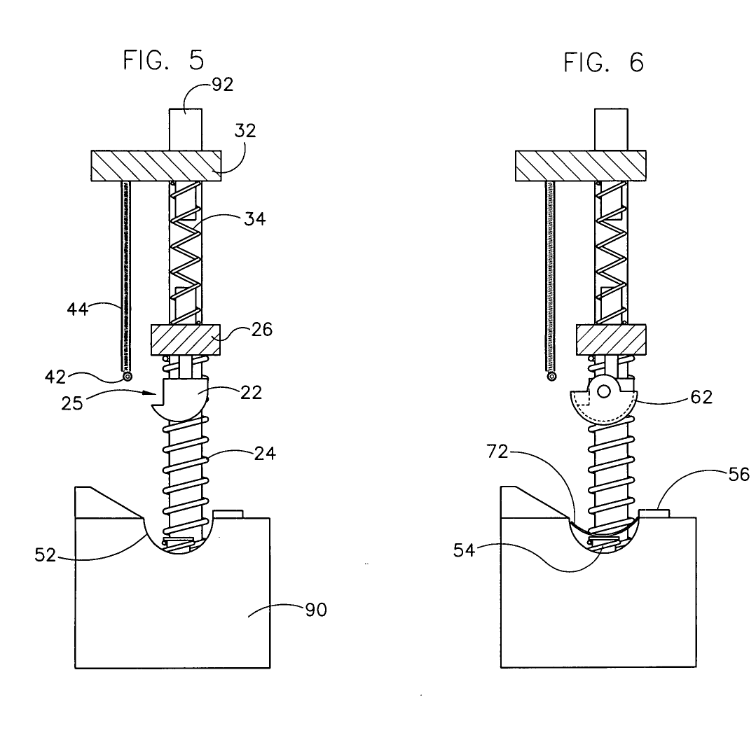

Referring now to FIGS. 5-8, the method of assembling a fabric piece 72 onto a rigid part 62 through operation of the machine 10 will now be described. A rigid part 62 is provided and placed onto the rigid part holder 22. This can done through either a hand operation or an automated feeder system. The rigid part 62 can be retained by the rigid part holder 22 through a variety of methods including a vacuum, spring retention clips, friction, suction cups, or adhesive. A fabric piece 72 is provided and placed in the cradle 52 of the fabric carrier 50. Preferably, the fabric piece 72 is aligned by mating the scallop cuts 74 in the fabric piece 72 to fabric stops 56 located on the fabric carrier 50. The fabric carrier 50 can be slid away from the rest of the components of the machine 10 to facilitate placement of the fabric 72 onto the fabric carrier 50. Once the fabric piece 72 is placed in the cradle 52, the fabric carrier 50 can be slid into proper placement. Alternatively, the fabric carrier 50 could be fixed into position with fabric pieces 72 sequentially fed to it.

As described in more detail below, the fabric pieces 72 preferably have some kind of adhesive already applied to them, such as a heat-activated adhesive, e.g., hot-melt glue. If the fabric piece 72 has been coated with a heat-activated adhesive, heat is applied to the adhesive on the fabric piece 72 after placement in the fabric carrier 50 and immediately prior to contact with the rigid part 62. Heat can be applied to the adhesive in a number of ways including, but not limited to: passing the fabric carrier 50 through a conveyor-type heat source, heating the fabric carrier 50, or heating the rigid part 62.

When adhesive is applied to the portion or roll of fabric, fabric piece should preferably be as wide and long as possible to maximize efficiency. The larger the piece of fabric is, the more efficient the adhesive application process.

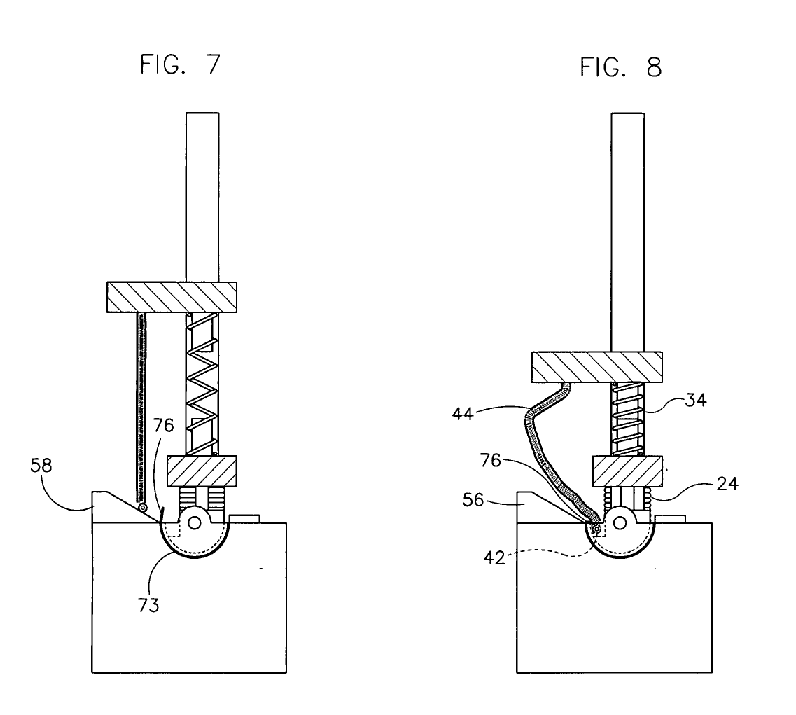

FIG. 7 shows the machine 10 with downward pressure applied to the pressing plate 32. The pressure can be applied manually or through an automated method such as an electric actuator (not shown). The holding springs 24 have a lower k value, which means that they require less force to compress than the pressing springs 34 and therefore are compressed first. When the holding springs 24 are compressed, the support plate 26, rigid part holder 22 and rigid part 62 move towards the fabric piece 72. The outside surface 66 of the rigid part 62 eventually comes into contact with the heated adhesive-coated side of the fabric piece 72. The rigid part 62 continues to be pressed against the fabric piece 72, thereby compressing the fabric supporting springs 54 and ultimately seating the rigid part 62 against the fabric piece 72 in the cradle 52. At this point, most of the fabric piece, i.e., a first portion, 73 is sandwiched between the rigid part 62 and the cradle 52. The fabric supporting springs 54 are compressed below the surface of the cradle 52 into their respective recesses. Preferably, the resulting shape of the first portion 73 causes an end portion 76 of the fabric piece 72 to extend above the edge 68 of the rigid part 62.

After the holding springs 24 are fully compressed and with the downward pressure still being applied, the pressing springs 34, having a higher k value, begin to compress thereby further lowering the pressing plate 32 and rollover unit 40. As the pressing springs 34 are compressed, the roller 42 comes into contact with the rollover ramp 58. As the roller 42 is forced down the rollover ramp 58, the rollover springs 44 begin to bend sideways. The rollover springs 44 provide constant pressure to the roller 42 against the rollover ramp 58. The constant pressure is important to help enable the roller 42 to contact only the non-adhesive coated side of the end portion 76 of the fabric piece 72 to initiate a fabric rollover operation. The pressure could be applied by means other than the rollover springs 44, including, but not limited to: spring wire, spring metal sheet stock, an actuator, rotational springs or polymer springs. Furthermore, the roller 42 need not necessarily have the shape or function of a roller. The roller 42 could be replaced with a thin fixed part, such as a rigid wire, a wedge shape or an assembly that could reliably and repeatedly travel down the ramp, contact the non-adhesive coated side of the fabric piece 72 and transfer adequate pressure across its width. Furthermore, the rollover operation could occur on both sides of the rigid part 62 by mirroring the roller 42, rollover springs 44, rollover ramp 58 and rigid part holder cutout 25.

Preferably, the roller 42 folds the end portion 76 of the fabric piece 72 over the edge 68 of the rigid part 62 and onto the inside surface 64 of the rigid part 62. The cutout 25 in the rigid part holder 22 provides clearance for the roller 42 to travel inside the rigid part 62. In one embodiment, the automatic rollover operation beneficially applies pressure across the entire application surface of the fabric piece 72, including the outside surface 66, inside surface 64 and edge 68 of the rigid part 62.

After the fabric piece 72 is fully situated on the rigid part 62, the pressure on the pressing plate 32 is released. The pressing springs 34 and holding springs 24 decompress thereby returning the machine 10 to its original state. The fabric coated rigid part, i.e., roller assembly, 60 can then be removed from the rigid part holder 22. The roller assembly 60 with its bonded fabric piece 72 bonded to the rigid part 62 is complete. The roller assembly 60 is then permitted to cool. In an alternative embodiment, the roller assembly 60 is released prior to the machine 10 returning to its original state. In this embodiment, the fabric supporting springs 54 push the roller assembly 60 out of the cradle 52 for transport or removal.

Preferably, in one embodiment the fabric piece 72 is pre-coated with heat-activated adhesive. First, the fabric piece 72, e.g., a cleaning fabric or unidirectional velour, is provided in manufactured rolls. Next, a width of fabric is coated on one side, i.e., the backside, with a heat activated adhesive, e.g., “hot melt” glue. The now adhesive-coated roll of fabric is allowed to cool, preferably at least for a few seconds. Finally, the cooled adhesive-coated roll of fabric is cut to a final shape to produce fabric pieces 72.

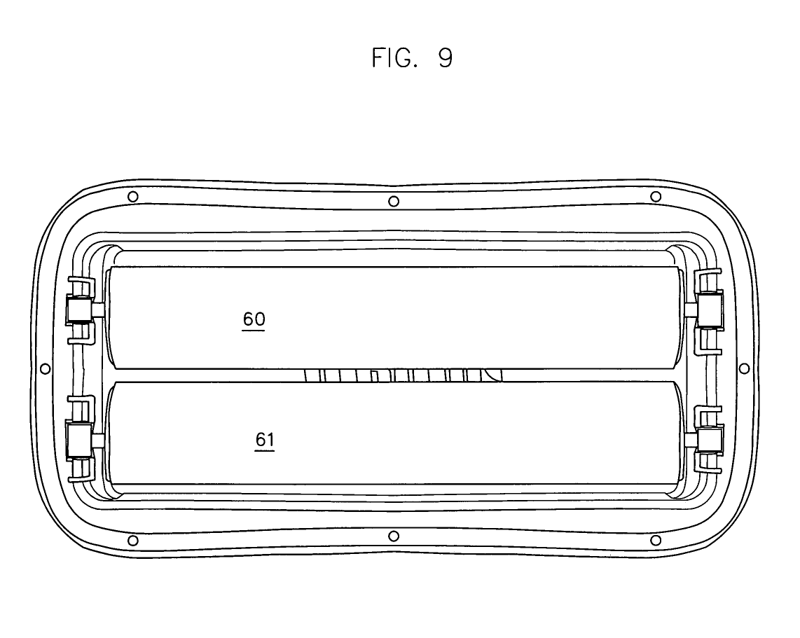

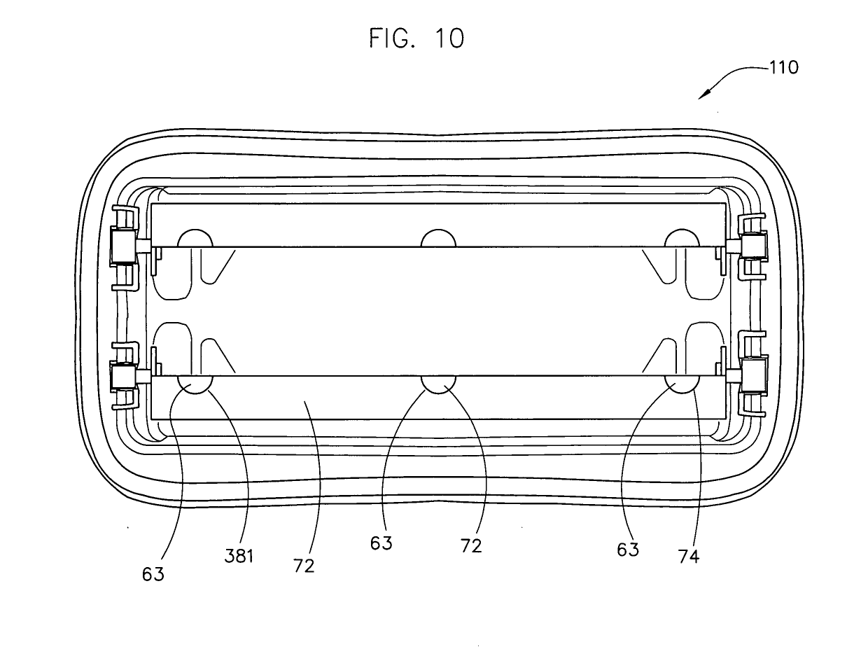

One advantage of this adhesive-coating process is the ability to apply adhesive to full roll of fabric at a high speed rather than a labor-intensive method of applying adhesive to each individual fabric piece 72. Another advantage of this process is the ability to apply adhesive at any time rather than immediately before assembly onto a roller. Furthermore, pre-coating the fabric pieces 72 prevents their edges from fraying prior to being bonded to the rigid part 62. After the rollers 60, 61 are completed, they are then preferably added to a base or bottom portion 112 as shown in FIG. 9.

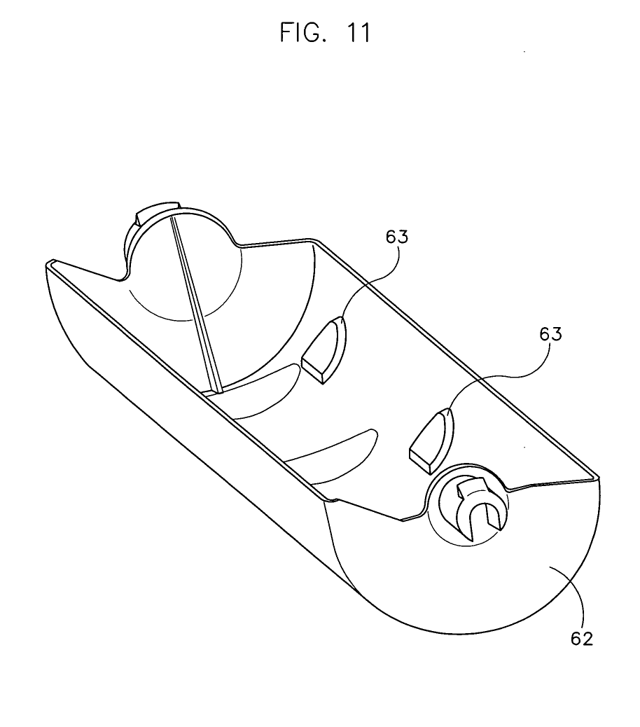

FIG. 10 shows the bottom of a fabric-cleaning device or sweeper 110 with scallop cuts 74 in the fabric piece 72. One embodiment has mating bosses 63 on the roller assemblies 60, 61. In other embodiments, these scallops cuts 74 are not necessary as the fabric piece 72 may just be cut into rectangles and folded over both edges of the rigid part 62 and not just the one as previously described. In another embodiment shown in FIG. 11, the mating bosses 63 may be located on the inside surface 64 of the fabric roller assemblies 60, 61.

In an alternative embodiment, the fabric piece 72 may be applied to a rigid part 62 as a sort of label, that is, with one side having a non-heat activated adhesive and the other side having a unidirectional fabric. In one embodiment, the fabric piece 72 is red velour; however, gray, blue and other, lighter colors such as white and yellow may be used. Lighter colors may be beneficial by better showing dirt and debris. The fabric piece 72 preferably has some cushion. The cushion density makes a difference in the amount of required exerted force. The velour fabric pieces 72 may wear out after time. For example, in one embodiment it wears out after 6 hours to 8 hours of use. After the fabric wears out, the device 110 may be disposed of.

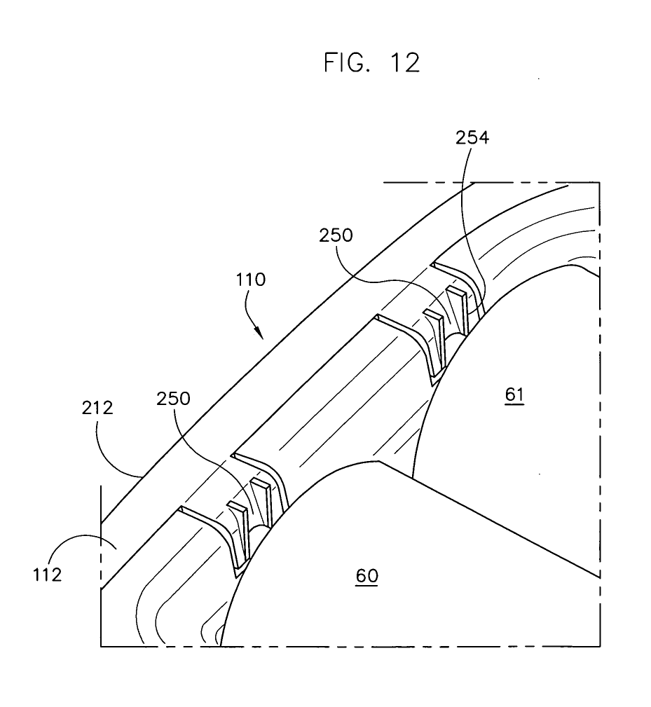

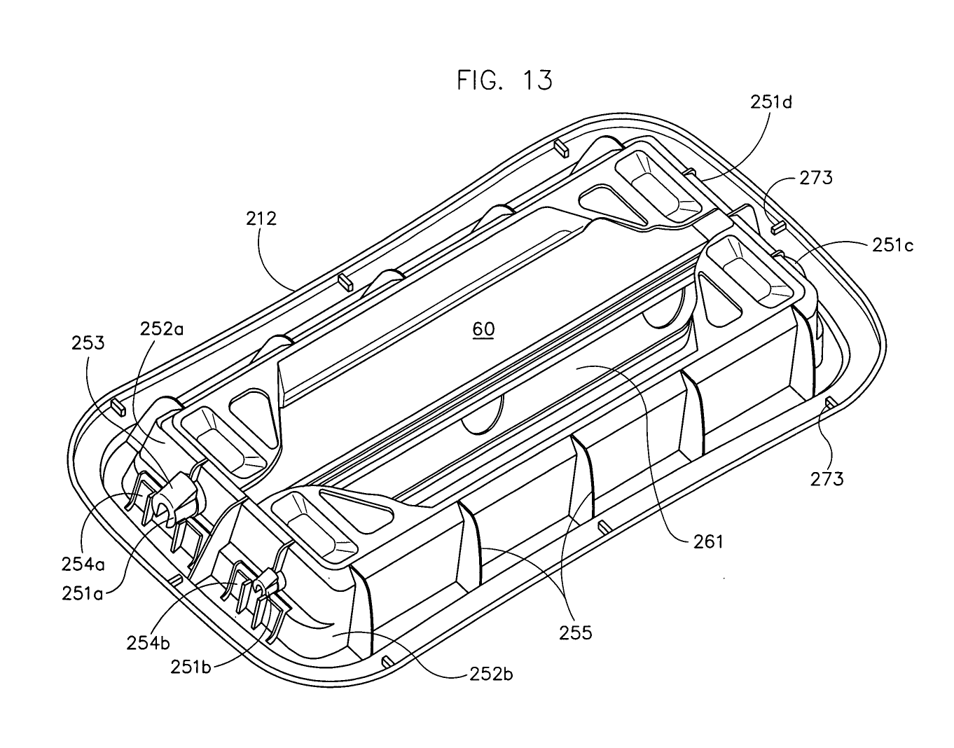

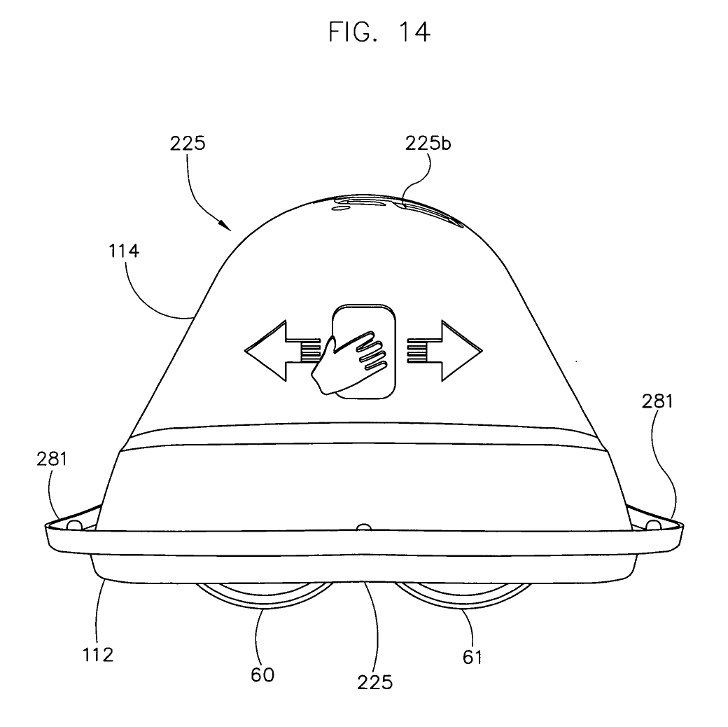

FIGS. 12 and 13 show one embodiment with the roller assemblies 60, 61 fastened within a base portion 112 of the cleaning device 110. The base portion 112 is preferably molded from a rigid plastic. The bottom of the base portion 112 of the device 110 has ramps or leads 250 to help assemble the roller assemblies 60, 61 into the base 112. In this embodiment, the roller assemblies 60, 61 have protruding axles 251a-251d of differing sizes which that are received into corresponding receiving cavities 252a-d, primarily to prevent misassembly during the production process. Living hinges 254a-d assist in the installation of rollers 60, 61 into the bottom portion 112 by flexing outwards during the assembly process. Locks 253 further secure roller assemblies 60, 61 into the base portion 112.

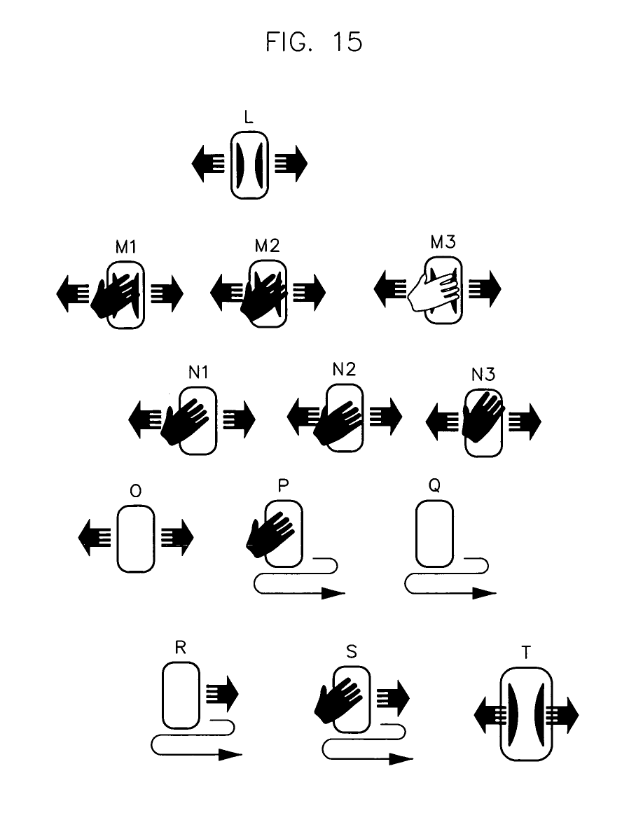

FIG. 14 shows one embodiment of a fabric sweeper 110 with a handle portion 114 attached to the base portion 112. Preferably, the handle portion 114 is formed via vacuum or thermal molding to a thickness sufficient to prevent crushing during use. The handle portion 114 is molded with a clear plastic to aid in viewing the contents of the sweeper 110. Indicia 225 on the handle portion 114 preferably includes a logo or brand name 225b and directions for use 225a. FIG. 15 shows various logos that could be added to the handle portion 114 to assist in using the fabric sweeper 110. The indicia 225 preferably can be molded into the handle portion 114, but can also be pre-printed in the plastic or applied as a sticker. If the indicia 225 are integrated into a mold, they can be textured differently, i.e., made more opaque, from the rest of the handle portion 114 in order for them to stand out.

Preferably, the rollers 60,61, base portion 112 and handle portion 114 are assembled in the following order. First, the rollers 60, 61 are installed into the base portion 112 by inserting the axles 251a-d through the corresponding receiving cavities 252a-d. The base portion 112 and handle portion 114 are then bonded together, preferably via heat-staking, to form a complete fabric sweeper 110. Ribs may be added to living hinges 254a-d extending to the handle portion 114 to help prevent the rollers 60, 61 from being removed from the fabric sweeper 110. The embodiments shown in FIGS. 13 and 14 utilize heat staking to connect bottom portion 112 to the handle portion 114 to form the fabric sweeper 110. FIG. 13 shows heat staking connector tabs 273 that are heated and fit into corresponding receptacles 281 in the handle portion 114. Multiple ribs 255 help keep the handle portion 114 and bottom portion 112 properly aligned during the heat staking process. Ribs 255 also add rigidity and strength to the finished device 210 which can help prevent accidental crushing when using the fabric cleaning device 110. FIG. 14 shows a different type of post for heat-staking the base portion 112 and handle portion 114. Stakes 271 are used rather than tabs 273 discussed above. Heat staking is preferable to other methods, e.g., adhesive, screws, snaps, because it is less costly while forming a strong bond between dissimilar materials.

FIG. 15 is a diagram of various graphics of directions of use of a fabric sweeper device of the present invention. These graphics may be embossed into the device, printed on the device, added by a decal, or attached in any of variety of ways. Of course, the use and operation of fabric cleaner or sweeper 110 is described in more detail in co-pending U.S. patent application Ser. No. 11/450,315.

There are many more uses for the present invention, all of which need not be detailed here. Further, although the best mode contemplated by the inventor of carrying out the present invention is disclosed above, practice of the present invention is not limited thereto, e.g., it will be manifest that various additions, modifications and rearrangements of the features of the present invention may be made without deviating from the spirit and scope of the underlying inventive concept. For example, in one alternative embodiment, the velour cloth has an acrylic coating. As this coating would prevent the velour cloth from fraying when it is cut to size, it may not be necessary to apply the adhesive or bonding agent to the fabric first. Moreover, rather than using a heat sensitive adhesive, a pressure sensitive, or air curing adhesive may be used. Further, it is not necessary to use a heat based assembly method, because a non-heat based alternative, such as, radiant heat (lights), or microwave may be used to soften the adhesive. In fact, some other fabric bonding process may be used altogether, such as, ultrasonic welding or some other type of welding process. Any of these types of assembly may be used in conjunction with an anti-fraying fabric coating.

It is also possible to heat to up the adhesive on the fabric by first heating the fabric rather than the adhesive directly. Further, the roll containing the fabric may be heated to soften the adhesive. Alternatively, the roll carrier could be heated.

While unidirectional velour is the fabric of choice, any similar material could be used in its place. In addition, the individual components of the machine or device described herein need not be fabricated from the disclosed materials, e.g., plastic, but could be fabricated from virtually any suitable materials.

Moreover, the individual components need not be formed in the disclosed shapes, or assembled in the disclosed configuration, but could be provided in virtually any shape, and assembled in virtually any configuration. Further, although many components are described herein is a physically separate module, e.g., the bottom portion of the device or the rollers, it will be manifest that they may be more fully integrated into the components with which they are associated. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A method of manufacturing a fabric sweeper, the method comprising the steps of:
providing a heat-activated adhesive-coated fabric piece;
placing the heat-activated adhesive-coated fabric piece in a fabric carrier;
applying heat to the adhesive; and
contacting a surface of a rigid part with a side of the heated adhesive-coated fabric piece.

2. The method of claim 1, further comprising the step of forming a handle portion from a plastic and forming directions for use therein.

3. The method of claim 2, further comprising the steps of:
connecting the rigid part to a base via receiving cavities; and
connecting the base to the handle portion by heat staking.

4. The method of claim 1, wherein the providing step comprises the following steps:
coating a side of a roll of fabric with a heat-activated adhesive;
allowing the roll of fabric to cool; and
cutting the fabric roll to produce at least shaped pieces of adhesive-coated fabric.

5. The method of claim 1, wherein the rigid part is retained in a holder by one of the following methods: vacuum, spring retention clips, friction, suction cups, and adhesive.

6. The method of claim 1, wherein the fabric carrier comprises a cradle and fabric supporting springs.

7. The method of claim 6, wherein the fabric carrier further comprises fabric stops.

8. The method of claim 7, wherein the fabric stops align with notches in the fabric pieces.

9. The method of claim 1, wherein the heat is applied to the adhesive in at least one of the following manners: passing the carrier through a conveyor-type heat source, heating the fabric carrier, and heating the rigid part.

10. The method of claim 6, further comprising the steps of:
pressing the rigid part against the heated adhesive-coated fabric piece;
sandwiching a first portion of the fabric piece between the rigid part and the cradle;
folding a second portion of the fabric piece onto another side of the rigid part; and
releasing the rigid part after the fabric piece has bonded to the rigid part.

11. The method of claim 10, wherein the folding step is accomplished by a bar pressing the second portion of the fabric piece over an edge of the rigid part and onto the opposite side of the rigid part.

12. A machine for assembling a fabric cleaner, the machine comprising:
a pressing unit having a pressing plate and pressing springs;
a rigid part holding unit having a rigid part holder and holding springs engaged with the pressing unit;
a rollover unit, having a roller and rollover springs; wherein the rollover unit pushes a portion of the fabric piece onto a surface of a rigid part; and
a fabric carrier comprised of a rollover ramp, fabric springs, and a cradle.

13. The machine of claim 12, wherein the pressing unit, rigid part holding unit and rollover unit are operably engaged to each other by biasing members.

14. The machine of claim 12, wherein the fabric carrier is separable from the other components of the machine.

15. The machine of claim 12, further comprising a force applying component.

16. The machine of claim 15, wherein the force applying component is a handle.

17. The machine of claim 15, wherein the force applying component is an automatic actuator.

18. The machine of claim 12, wherein the fabric carrier has stops to align the fabric piece.

19. A workpiece assembly for applying a velour fabric onto a semicircular tubular member to produce a fabric sweeper, the workpiece assembly comprising:
a first section comprising a support for the tubular member and a first biasing member;
a second section comprising a plate and a second biasing member; wherein the second section is operably engaged to the first section;
a third section comprising a bar and a third biasing member; the third section operably engaged to the first section; and
a fourth section comprised of a bar guiding member and a fabric support; wherein the first section and second section are connected together by supporting members; and wherein the bar applies pressure to a portion of the fabric piece against a another surface of a rigid part.

20. The machine of claim 19, wherein the fourth section has aligning members that are protrusions that align with cuts in the fabric; and further comprising a fifth section comprising a base and supporting members.
